(19) United States
(12) Patent Application Publication
(10) Pub. No.: US 2007/0297795 A1
(43) Pub. Date: Dec. 27, 2007

(54) Bidirectional Optical Communication System

(76) Inventors: Osamu Kinoshita, Kawasaki-shi (JP); Seiichi Kawada, Fujisawa-shi (JP); Takaaki Morita, Yokohama-shi (JP)

Correspondence Address: DAY PITNEY LLP, 7 TIMES SQUARE, NEW YORK, NY, 10036-7311, US

(21) Appl. No.: 11/666,400

(22) PCT Filed: Nov. 15, 2004
(86) PCT No.: PCT/JP04/16964

§ 371 Date: Apr. 26, 2007

(51) Int. Cl. H04B 10/24

(52) U.S. Cl. 398/41

(57) ABSTRACT

A bidirectional optical communication system employing a living line and a standby line. One of a master unit and a slave unit has a photoswitch for switching between the living line and the standby line and the other has a photocoupler for collecting the living line and the standby line. When deterioration in communication state of the living line is detected on the side having the photoswitch, the photoswitch on that side is switched to use the standby line.

### BACKGROUND OF THE INVENTION

The present invention relates to a communication system using an active line and a standby line for improving reliability of communication.

In order to transmit large amounts of information, for example, a communication system by means of optical communication is utilized. An example of a large amount of information includes image information, and that of a live telecast, the above communication system is utilized. It is important in a live telecast to avoid an incident causing interruption of image. For this purpose, the communication cable of the communication system is multiplexed. For example, the active line and the standby line are used for communication (Jpn. unexamined patent publication No. 8-293854).

FIG. 1 is a diagram exemplifying the conventional communication system by means of the active line and the standby line used for optical communication. The communication system comprises the master apparatus 101, and the slave apparatus 102. The master apparatus 101 comprises the first transmitter/receiver unit 103, and the first optical switching unit 104, and the slave apparatus 102 comprises the second transmitter/receiver unit 105, and the second optical switching unit 106.

The first optical switching unit 104 comprises the terminals 109, 110, and 111. The terminal 109 is connected to the first transmitter/receiver unit 103, the terminal 110 is connected to the active line 107, and the terminal 111 is connected to the standby line 108. The first optical switching unit 104 is able to connect the terminal 109 to the terminal 110 or 111. Similar to the above configuration, the second optical switching unit 106 comprises the terminal 102, 113, and 114. The terminal 112 is connected to the second transmitter/receiver unit 105, the terminal 113 is connected to the active line 107, and the terminal 114 is connected to the standby line 108. The second optical switching unit 106 is able to connect the terminal 102 to the terminal 113 or 114.

As shown in FIG. 1, the terminal 109 is connected to the terminal 110 in the first optical switching unit 104, and the terminal 112 is connected to the terminal 113 in the second optical switching unit 106, so that it becomes possible to the communication by means of the active line 107 is carried out. If interruption occurs in the active line 107, the terminal 109 and the terminal 111 are connected in the first optical switching unit 104, and the terminal 112 and the terminal 114 are connected in the second optical switching unit 106, so that communication by means of the standby line 108 is carried out.

Further, FIG. 2 is a diagram exemplifying a configuration of the optical switching unit used for the first optical switching unit 104 and the second optical switching unit 106. The optical switching unit comprises the input/output terminal 201, 202, 203, and the mirror 204. When the mirror 204 is inserted, optical transmission/reception between the input/output terminal 202 and 203 becomes possible. Accordingly, for example, as a result of the communication between the input/output terminal 202 and the terminal 110, between the input/output terminal 201 and the terminal 111, and between the input/output terminal 203 and the terminal 109, the first optical switching unit 104 can be configured. Similarly, the above can be applied to the second optical switching unit 106.

Note that, although selection of two-to-one optical input/output is possible in FIG. 2, selection of two-to-two optical input/output is also possible.

FIG. 3 is a diagram exemplifying a configuration of the optical switching unit, which is able to select two-to-two optical input/output. The optical switching unit shown in FIG. 3 comprises the input/output terminal 201, 202, 203 and 205. When the mirror 204 is inserted, optical transmission/reception between the input/output terminal 201 and 205, and between the input/output terminal 202 and 203 become possible. Meanwhile, when the mirror 204 is not inserted, optical transmission/reception between the input/output terminal 201 and 203, and between the input/output terminal 202 and 205 become possible.

The cited document: Jpn. unexamined patent publication No. 8-293854

According to the configuration the master apparatus and the slave apparatus comprise the optical switching unit, it is necessary to perform switching in the first optical switching unit of the master apparatus and in the second optical switching unit of the slave apparatus at the same time. However, it is difficult to perform the switching at the same time. For example, for some reason, if the master apparatus detects the occurrence of temporary interruption such as instantaneous interruption of the active line, and the slave apparatus does not detect it, and the switching only in the first optical switching unit of the master apparatus is carried out, and communication between the master apparatus and the slave apparatus becomes impossible. Further, in cases where the switching are respectively performed in the master apparatus and the slave apparatus, if the timings of the switching are not same, the communication is impossible.

### BRIEF SUMMARY OF THE INVENTION

It is an objective of the present invention to carry out smooth switching between an active line and a standby line in a communication system using the active line and the standby line.

In order to achieve the above objective, according to the present invention, a communication system, wherein one of the master apparatus or the slave apparatus comprises an optical switching unit, the other comprises an optical coupler unit, and if bad communication status of the active line is detected in the apparatus comprising the optical switching unit, the standby line is used by causing the optical switching unit to perform switching to the standby line, is provided.

The optical switching unit exists only in the master apparatus or the slave apparatus, so that it enables smooth switching between the active line and the standby line. Accordingly, the above deficiency is overcome.

The apparatus comprising the optical switching unit monitors the optical signal transmitted from said slave apparatus via said standby line, and if level of said optical signal is lower than a predetermined level or is undetectable, the connection to said optical switching unit may be maintained.

According to the above configuration, even if the apparatus, which does not comprise the optical switching unit, becomes unable to transmit the signal for some reason such as a maintenance problem, the active line remains in use, so that it becomes possible to avoid interruption of signals due to unnecessary switching in the optical switching unit.

In addition, in cases where the standby line is used, the apparatus comprising the optical switching unit may be able to acquire an approval signal for returning to the active line.

According to the above configuration, in the case of recovery of the active line from interruption, it becomes possible to return to the active line at the appropriate moment.

As described above, according to the present invention, it becomes possible to carry out smooth switching between an active line and a standby line in a communication system using the active line and the standby line.

### BRIEF DESCRIPTION OF THE DRAWINGS

Accompanying the specification are figures which assist in illustrating the embodiments of the invention, in which:

FIG. 1 is a diagram exemplifying the conventional communication system;

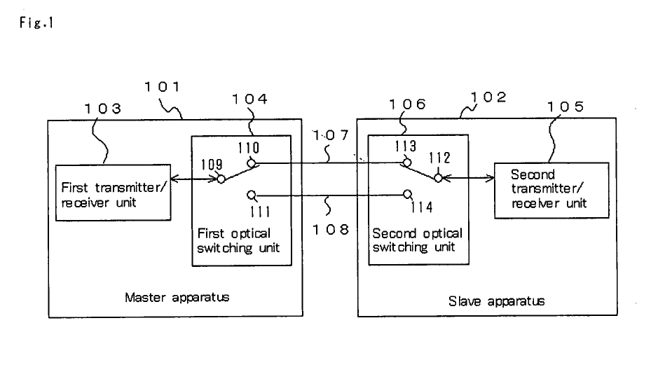

FIG. 2 is a diagram exemplifying a configuration of the optical switching unit;

FIG. 3 is a diagram exemplifying a configuration of the optical switching unit;

FIG. 4 is a functional block diagram of the bidirectional optical communication system of the first embodiment of the present invention;

FIG. 5 is a diagram exemplifying a configuration of the first receiver/transmitter 403;

FIG. 6 is a diagram exemplifying a configuration of the second receiver/transmitter 407;

FIG. 7 is a schematic diagram of the configuration of the optical coupler unit;

FIG. 8 is a diagram exemplifying a configuration of the optical coupler unit;

FIG. 9 is a diagram illustrating driving of the optical switching unit 404 by the optical switch driving unit 405;

FIG. 10 is a flow chart explaining processing flow in the master apparatus;

FIG. 11 is a functional block diagram of the master apparatus of the bidirectional optical communication system of the second embodiment of the present invention;

FIG. 12 is a diagram illustrating connection between the first receiver/transmitter and the level monitoring unit;

FIG. 13 is a flow chart explaining processing flow in the master apparatus;

FIG. 14 is a functional block diagram of the master apparatus of the bidirectional optical communication system of the second embodiment of the present invention;

FIG. 15 is a functional block diagram of the master apparatus of the bidirectional optical communication system of the third embodiment of the present invention;

FIG. 16 is a flow chart explaining processing flow in the master apparatus;

FIG. 17 is a functional block diagram of the master apparatus of the bidirectional optical communication system of the fourth embodiment of the present invention;

FIG. 18 is a functional block diagram of the master apparatus of the bidirectional optical communication system of the fifth embodiment of the present invention;

FIG. 19 is a functional block diagram of the master apparatus of the bidirectional optical communication system of the sixth embodiment of the present invention;

FIG. 20 is a graph in which the horizontal axis 2001 indicates wavelength, and the vertical axis 2002 indicates optical signal level.

### DETAILED DESCRIPTION OF THE INVENTION

Embodiments of the present invention will be described hereinbelow with reference to the drawings. The present invention is not to be limited to the above embodiments and able to be embodied in various forms without departing from the scope thereof.

As the first embodiment of the present invention, a communication system, wherein one of the master apparatus or the slave apparatus comprises a switching unit, which is able to select an active line or a standby line, another comprises a coupler unit, which couples said active line and standby line, and if bad communication status of the active line is detected in the apparatus comprising the switching unit, the standby line is used by causing the switching unit to perform switching to the standby line, will be described. In addition, hereinbelow, the bidirectional optical communication system as an example of the above communication system, which carries out bidirectional optical communication by means of cables or fibers passed by optical signals, will be described.

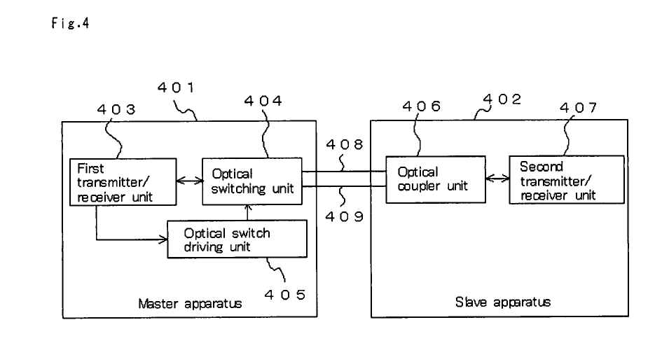

FIG. 4 is a functional block diagram of the bidirectional optical communication system of the first embodiment of the present invention. The bidirectional optical communication system comprises the master apparatus 401 and the slave apparatus 402.

The master apparatus 401 comprises the first transmitter/receiver unit 403, and the optical switching unit 404, and the optical switch driving unit 405. The slave apparatus 402 comprises the optical coupler unit 406, and the second transmitter/receiver unit 407.

The master apparatus 401 and the slave apparatus 402 are able to carry out bidirectional communication by means of the active line 408 and the standby line 409. Note that the active line 408 and the standby line 409 consist of optical cable or optical fiber.

The ‘first transmitter/receiver unit’ 403 receives an optical signal. Therefore, it comprises transmission means for optical signal and reception means for optical signal.

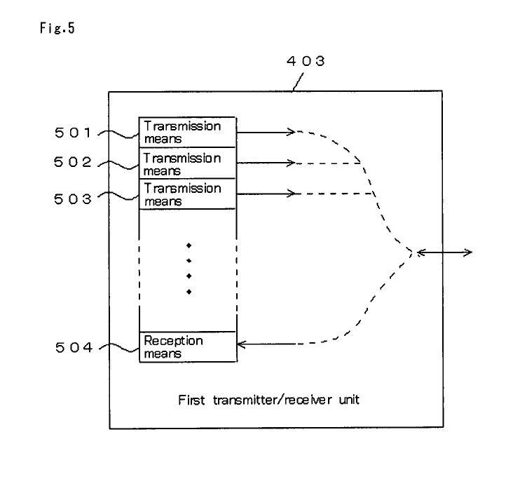

FIG. 5 is a diagram exemplifying a configuration of the first receiver/transmitter 403. The first transmitter/receiver unit 403 comprises the transmission means 501, 502, 503 etc., which transmit optical signals, and further comprises at least one reception means 504, which receives the optical signal. The communication path for transmitting the optical signal used by the transmission means 501, 502, 503, and the reception means 504 are finally assembled, and extracted to the outside of the first receiver/transmitter 403. Note that, for example, it is preferable that wavelengths of the optical signals transmitted by the respective transmission means are different, so that the signals transmitted by the transmission means 501, 502, and 503 are distinguishable by the receiver. Therefore, it is preferable that signals of multiple wavelengths are multiplexed and transmitted/received.

For example, a dielectric multilayer filter (TFF) transmits only an optical signal of any one wavelength, and reflects signals of all other wavelengths. Further, when an optical signal of any one wavelength is irradiated to the one side of the dielectric multilayer filter, and optical signals of multiplexed wavelengths are irradiated to the other side of it, all optical signals of multiplexed wavelengths are reflected, and the optical signal of any one wavelength irradiated to the one side is added. By means of this property, the transmission means 501, 502, and 503 etc. and the reception means 504 are linked together through TFF, so that it becomes possible to carry out multiplexing and transmission/reception of lights of multiple wavelengths.

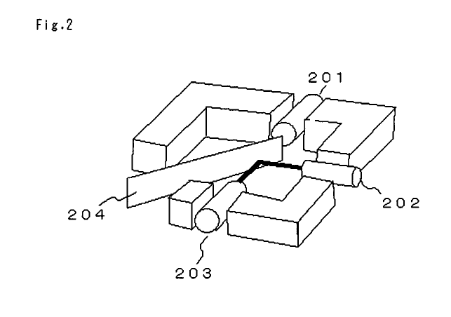

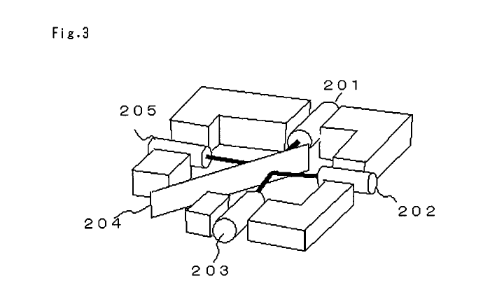

The ‘optical switching unit’ 404 is configured by a switch such as optical switches shown in FIG. 2 or 3, which is able to select the active line 408 or the standby line 409 to be connected to the first transmitter/receiver unit 403. Note that, distinction between the active line 408 and the standby line 409 may be relative. Therefore, a line currently connected to the first transmitter/receiver unit 403 may be named as an active line, and the other may be named as a standby line. Alternatively, distinction between the active line 408 and the standby line 409 may be absolute. Therefore, the line mainly used may be named as an active line.

The ‘optical switch driving unit’405 is for driving the optical switching unit 404. In cases where the optical switching unit 404 is configured by the optical switch shown in FIG. 2 or 3, it controls insertion/removal of the mirror 204. For example, by controlling an actuator, insertion/removal of the mirror 204 is carried out.

The ‘optical coupler unit’ 406 couples the active line 408 and the standby line 409. Therefore, it couples optical signals to be transmitted to the slave apparatus 402 via the active line 408 and the standby line 409, and separates the optical signal transmitted from the second transmitter/receiver unit 407, which will be described hereinbelow, and outputs them via the active line 408 and to the standby line 409.

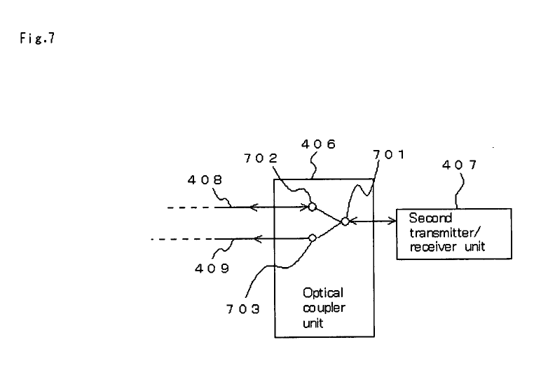

FIG. 7 is a schematic diagram of the configuration of the optical coupler unit. In the optical coupler unit 406, the terminal 701, 702, and 703 exist, the terminal 701 is connected to the second transmitter/receiver unit 407, the terminal 702 is connected to the active line 408, and the terminal 703 is connected to the standby line 409. The optical signals transmitted to the slave apparatus 402 via the active line 408 and the standby line 409 are coupled and transmitted to the terminal 701, and outputted to the second transmitter/receiver unit 407. Meanwhile, the optical signal transmitted to the terminal 701 by the second transmitter/receiver unit 407 is separated and transmitted to the terminal 702 and the terminal 703, and outputted to the active line 408 and the standby line 409.

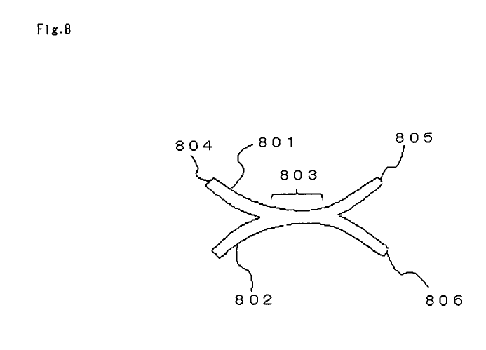

FIG. 8 is a diagram exemplifying a configuration of the optical coupler unit 406. In FIG. 8, the optical coupler is configured by two optical fibers 801 and 802, which have been fusion bonded at the portion 803. By means of this configuration, the optical signal inputted to the edge point 804 is separately outputted to the edge point 805 and 806. Meanwhile, the optical signals inputted to the edge point 805 and 806 are coupled and are outputted to the edge point 804. Accordingly, by relating the edge point 804 to the terminal 701, and by relating the edge point 805 and 806 to the terminal 702 and 703, respectively, the optical coupler 406 can be configured.

The ‘second transmitter/receiver unit’ 407 receives an optical signal. Further, as described above, it is connected to the optical coupler unit 406. The second transmitter/receiver unit 407 comprises transmission means for optical signal and reception means for optical signal.

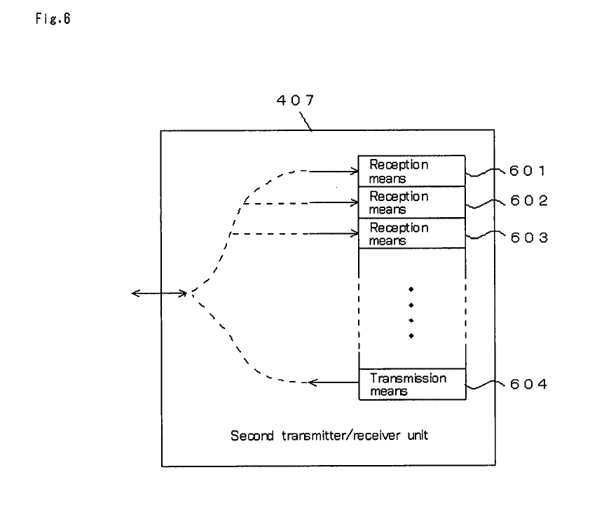

FIG. 6 is a diagram exemplifying a configuration of the second receiver/transmitter 407. The second transmitter/receiver unit 407 comprises the reception means 601, 602, 603 etc., which receive optical signals, and further comprises at least one transmission means 604, which transmits the optical signal. The communication path for transmitting the optical signal used by the reception means 601, 602, 603, and the transmission means 604 are finally assembled, and extracted to the outside of the second receiver/transmitter 407. Note that, for example, it is preferable that wavelengths of the optical signals received by the respective reception means are different, so that the signals received by the reception means 601, 602, and 603 are transmitted from different transmission means. For example, as described above, multiplexing the wavelengths is carried out by means of TFF. Therefore, it is preferable that the reception means 601 receives the light of the wavelength transmitted by the transmission means 501, the reception means 602 receives the light of the wavelength transmitted by the transmission means 502, and the reception means 603 receives the light of the wavelength transmitted by the transmission means 503.

In the first embodiment, the optical switching unit 404 is driven by the optical switch driving unit 405 in the master apparatus 401 as described hereinbelow. Normally, the active line 408 and the first transmitter/receiver unit 403 are connected. If bad communication status of the active line 408 is detected through the optical signal received by the first transmitter/receiver 403, the standby line 409 and the first transmitter/receiver unit 403 are connected. The terms ‘bad communication status’ means, for example, the level of the optical signal transmitted from the slave apparatus decreases, so that communication becomes impossible or almost impossible. Further, a state, in which the interruption in communication occurs, for example, an error concerning parity increases, or a state, in which occurrence of the interruption is expected, is caused. This bad communication status is, for example, detected by the reception means of the first transmitter/receiver unit 403. Alternatively, a monitoring unit for communication status of the active line other than the reception unit of the first transmitter/receiver unit 403 may be provided.

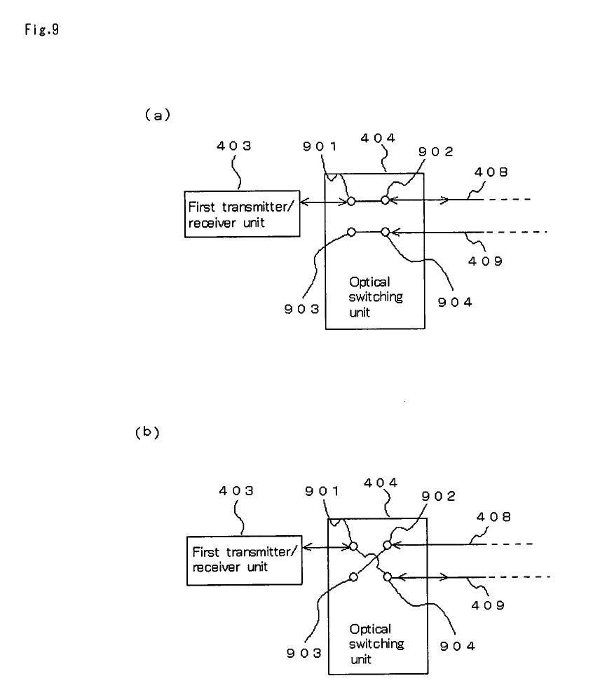

FIG. 9 is a diagram illustrating driving of the optical switching unit 404 by the optical switch driving unit 405. FIG. 9 (a) shows a normal state, in which the active line 408 and the first transmitter/receiver unit 403 are connected. For example, in cases where the optical switching unit 404 is configured by means of the optical switch shown in FIG. 3, the terminal 901, 902, 903, and 904 are related to the input/output terminal 201, 203, 202, and 205, respectively, and the mirror 204 is removed. FIG. 9 (b) shows a connection state in cases where bad communication status of the active line 408 is detected. The terminal 901 and 904 are connected, and the standby line 409 and the first transmitter/receiver unit 403 are connected. This state corresponds to the state shown in FIG. 3, in which the mirror 204 is inserted into the optical switch.

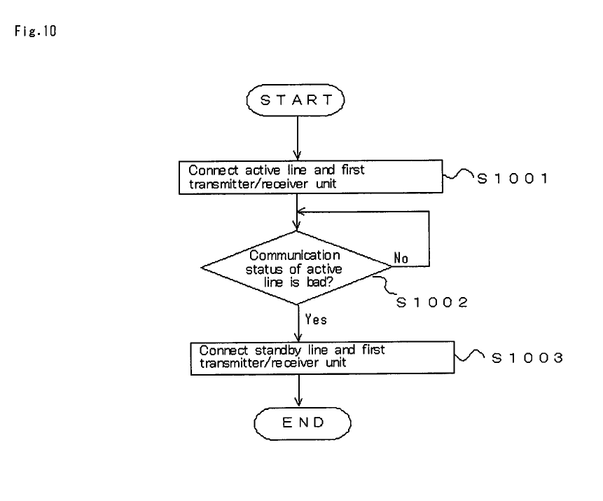

FIG. 10 is a flow chart explaining processing flow in the master apparatus. In step S1001, the active line and the first transmitter/receiver unit are connected (the connection step in a normal state). This is a normal connection. After that, in step S11002, detection of bad communication status of the active line is awaited. If bad communication status of the active line is detected, in step S1003, the standby line and the first transmitter/receiver unit are connected (the connection step in abnormal state).

Note that, after the standby line and the first transmitter/receiver unit are connected, the names of the standby line and the active line may be exchanged. Therefore, this is the case where distinction between the active line and the standby line is relative, so that the communication path, to which the code 408 is attached, may be named as active line. In such case, after the processing of step S1003, names of the standby line and the active line are exchanged and step S1002 is carried out.

According to the first embodiment, the optical switching unit exists only in the master apparatus, so that it enables smooth switching between the active line and the standby line.

As the second embodiment of the present invention, the bidirectional optical communication system, wherein the master apparatus monitors the optical signal transmitted from said slave apparatus via said standby line, and maintains the connection to the optical switching unit if said level monitoring unit detects that level of the optical signal is lower than a predetermined level, or is undetectable.

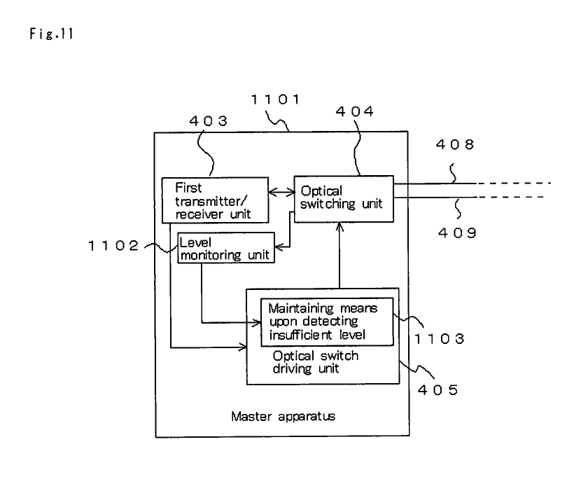

FIG. 11 is a functional block diagram of the master apparatus of the bidirectional optical communication system of the second embodiment of the present invention. The master apparatus 1101 comprises the first transmitter/receiver unit 403, and the optical switching unit 404, the optical switch driving unit 405, and the level monitoring unit 1102, and the optical switch driving unit 405 comprises the maintaining means upon detecting insufficient level 1103. The configuration of the slave apparatus is the same as that of the first embodiment. Therefore, the bidirectional optical communication system of the second embodiment is the bidirectional optical communication system according to the first embodiment, wherein the master apparatus comprises the level monitoring unit, and the optical switch driving unit comprises the maintaining means upon detecting insufficient level.

The ‘level monitoring unit’ 1102 monitors the optical signal transmitted from the slave apparatus 402 via the standby line 409. For example, the monitoring is carried out by measuring intensity of the optical signal or frequency of occurrence of errors in information in the optical communication. Therefore, the level monitoring unit 1102 is connected to the standby line.

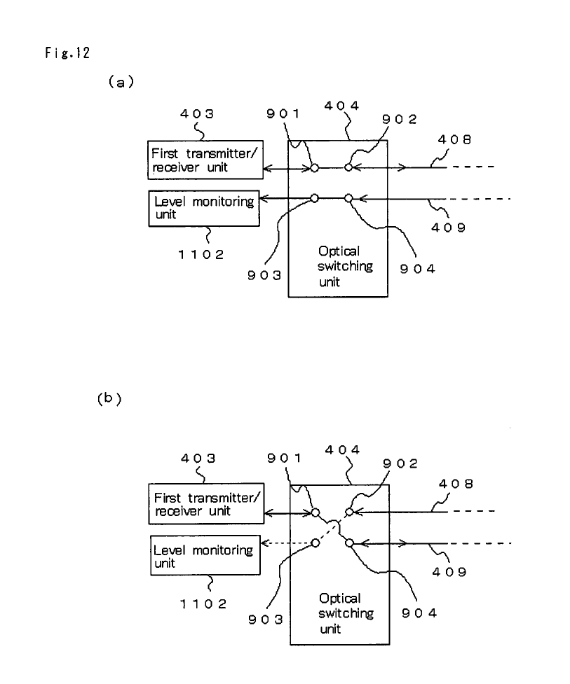

FIG. 12 is a diagram illustrating a connection between the first receiver/transmitter and the level monitoring unit. FIG. 12 (a) corresponds to the normal state. The optical switching unit 404 connects the active line 408 and the first transmitter/receiver unit 403, and the standby line 409 and the level monitoring unit 1102. FIG. 12 (b) corresponds to the state in which bad communication status of the active line is detected through the optical signal received by the first transmitter/receiver. The optical switching unit 404 connects the standby line 409 and the first transmitter/receiver unit 403, and may connect the active line 408 and the level monitoring unit 1102. For example, in cases where names of the active line and the standby line are exchanged due to the bad communication status of the active line, the communication line, to which the code 408 is attached, is connected to the level monitoring unit 1102.

The ‘maintaining means upon detecting insufficient level’ 1103 maintains the connection to the optical switching unit 404 if the level monitoring unit 1102 detects that level of said optical signal is lower than a predetermined level. Here, the term ‘said optical signal’ corresponds to the optical signal transmitted from the stave apparatus 402 via the standby line 409. Further, the terms ‘maintains the connection to the optical switching unit 404’ means that the connection between the active line 408 and the first transmitter/receiver unit 403 is maintained.

In the present invention, since the optical signal transmitted from the first transmitter/receiver unit is divided by the optical coupler unit of the slave apparatus, basically, the same optical signal is transmitted from the slave apparatus 402 via the active line 408 and the standby line 409. If an interruption such as disconnection of the standby line 409 occurs, connection between the standby line 409 and the first transmitter/receiver unit 403 is worthless, so that connection between the active line 408 and the first transmitter/receiver unit 403 is maintained. Further, in cases where a portion or all of the transmission means of the second transmitter/receiver unit 407 stop due to a maintenance of the second transmitter/receiver unit 407 etc., level of the optical signal received by the first transmitter/receiver unit 403 decreases or the optical signal received by the first transmitter/receiver unit 403 disappears even if any interruption occurs in the active line 408, so that there is a possibility that bad communication status of the active line is detected. However, there is no actual interruption in the active line 408, and switching between the active line and the standby line is unnecessary, so that connection between the active line 408 and the first transmitter/receiver unit 403 is maintained.

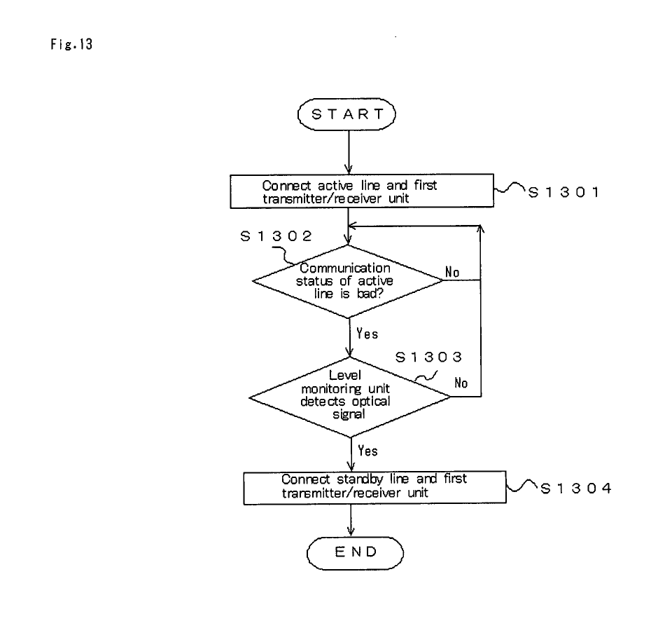

FIG. 13 is a flow chart explaining processing flow in the master apparatus. In step S1301, the active line 408 and the first transmitter/receiver unit 403 are connected (the connection step in normal state). In step S1302, detection of bad communication status of the active line is awaited. If bad communication status of the active line is detected, in step S1303, it is determined whether the level monitoring unit 1102 has detected an optical signal, in other terms, whether the level of the optical signal transmitted via the standby line 409 is lower than a predetermined level. If the optical signal has been detected, step S1304 is carried out. If not, processing returns to step S1302. In step S1304, the standby line 409 and the first transmitter/receiver unit 403 are connected (the connection step in abnormal state).

According to the second embodiment, it becomes possible to prevent unnecessary switching between the active line and the standby line in cases where the standby line is unavailable or it appears that interruption occurs in the active line. Specifically, in case where it appears that interruption occurs in the active line even if there is no actual interruption, it becomes possible to prevent instantaneous interruption of communication, which occurs upon switching from the active line to the standby line.

As the third embodiment of the present invention, the bidirectional optical communication system, wherein the master apparatus is able to acquire an approval signal for returning to a state of using the active line, will be described.

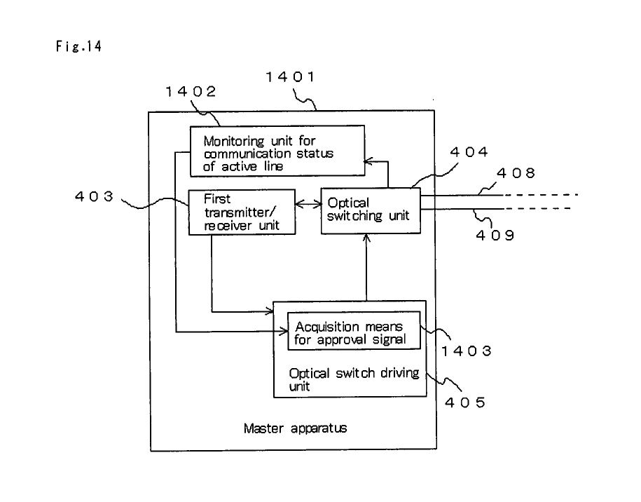

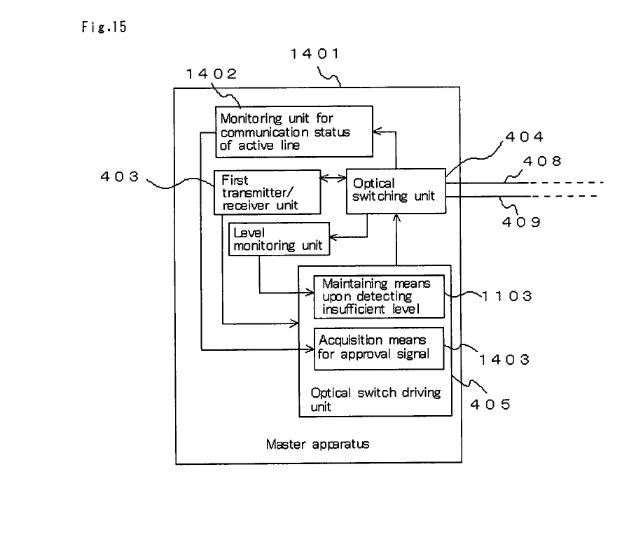

FIG. 14 is a functional block diagram of the master apparatus of the bidirectional optical communication system of the third embodiment of the present invention. The master apparatus 1401 comprises the first transmitter/receiver unit 403, and the optical switching unit 404, the optical switch driving unit 405, and the monitoring unit for communication status of active line 1402, and the optical switch driving unit 405 may comprise the acquisition means for approval signal 1403. In addition, as shown in FIG. 15, the master apparatus may comprise the level monitoring unit, and the optical switch driving unit may comprise the maintaining means upon detecting insufficient level. The configuration of the slave apparatus is the same as that of the first or second embodiment. Therefore, the bidirectional optical communication system of the third embodiment is the bidirectional optical communication system according to the first or second embodiment, wherein the master apparatus comprises the monitoring unit for communication status of active line, and the optical switch driving unit comprises the acquisition means for approval signal.

The ‘monitoring unit for communication status of active line’ 1402 is able to monitor a communication status of the active line 408. The monitoring unit for communication status of active line 1402 is able to monitor the communication status of the active line 408 even when the standby line 409 and the first transmitter/receiver unit 403 are connected. Therefore, as shown in FIG. 14 or 15, the monitoring unit for communication status of active line 1402 acquires the optical signal of the active line 408 from the optical switching unit 404. Alternatively, the optical signal transmitted from the slave apparatus via the active line 408 may be divided by an optical coupler etc., and may be acquired.

The ‘acquisition means for approval signal’ 1403 acquires an approval signal if the optical switching unit 404 of the master apparatus 1401 connects the standby line 409 to the first transmitter/receiver 403, and the monitoring unit for communication status of active line 1402 detects good communication status of the active line 408. Here, the term ‘approval signal’ corresponds to a signal for causing the optical switching unit 404 to connect the active line 408 and the first transmitter/receiver 403. For example, this signal is inputted from the input apparatus connected to the master apparatus 1401, and is acquired by the acquisition means for approval signal 1403. Alternatively, the signal, which indicates that the monitoring unit for communication status of active line 1402 detects good communication status of the active line 408 after bad communication status, may be an approval signal, and may be acquired by the acquisition means for approval signal 1403.

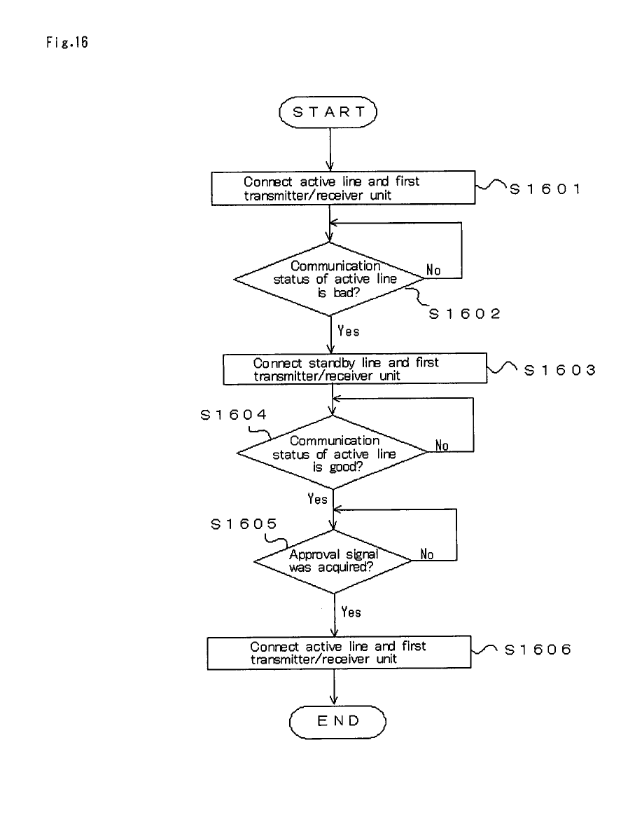

FIG. 16 is a flow chart explaining processing flow in the master apparatus. In step S1601, the active line 408 and the first transmitter/receiver unit 403 are connected (the connection step in normal state). In step S1602, detection of bad communication status of the active line is awaited. If bad communication status of the active line is detected, in step S1603, the standby line 409 and the first transmitter/receiver unit 403 are connected. After that, in step S1604, detection of good communication status of the active line 408 by the monitoring unit for communication status of active line 1402 is awaited. If the good communication status of the active line 408 is detected, in step S1605, acquisition of the approval signal by the acquisition means for approval signal 1403 is awaited. When the approval signal is acquired, in step S1605, the active line 408 and the first transmitter/receiver unit 403 are connected.

Note that, in cases where the master apparatus may comprise the level monitoring unit, and the optical switch driving unit may comprise the maintaining means upon detecting insufficient level as in the second embodiment, a step, which is for determining whether the level monitoring unit has detected the optical signal, is added between step S1602 and S1603. If the optical signal has not been detected, processing returns to step S1602, and if the optical signal has been detected, step S1603 is carried out.

According to the third embodiment, it becomes possible to return to a state of using the active line at appropriate timing in cases where interruption once occurs in the active line and is later recovered.

As the fourth embodiment of the present invention, the bidirectional optical communication system, wherein the ‘predetermined level’ described in the second embodiment is stored, will be described.

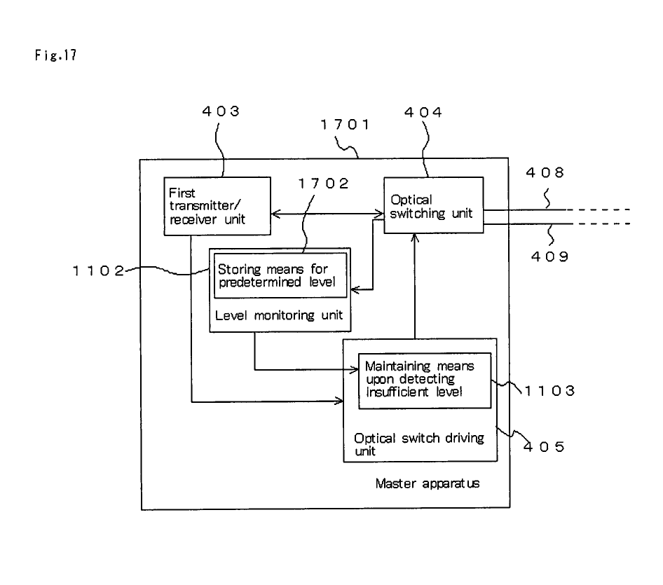

FIG. 17 is a functional block diagram of the master apparatus of the bidirectional optical communication system of the fourth embodiment of the present invention. The master apparatus 1701 comprises the first transmitter/receiver unit 403, and the optical switching unit 404, and the optical switch driving unit 405, and the optical switch driving unit 405 may comprise the maintaining means upon detecting insufficient level 1103, and the level monitoring unit 1102 comprises the storing means for predetermined level 1702. The configuration of the slave apparatus is the same as that of the second embodiment. Therefore, the bidirectional optical communication system of the fourth embodiment is the bidirectional optical communication system according to the second embodiment, wherein the level monitoring unit of the master apparatus comprises the storing means for predetermined level.

The ‘storing means for predetermined level’ 1702 stores said predetermined level. For example, in cases where a portion including the level monitoring unit 1102 is implemented by means of microcomputer etc., the storing means for predetermined level is configured by means of a flash memory, and the predetermined level is stored in the flash memory. Note that, the storing means for predetermined level may be configured by means of an ordinary semiconductor memory, instead of the memory such as a flash memory, which performs permanent storage. Accordingly, in the fourth embodiment, the level monitoring unit 1102 reads a predetermined level from the storing means for predetermined level 1702 according to necessity, and compares the read level and the level of the optical signal transmitted from the slave apparatus via the standby line. The terms ‘according to necessity’ refers to such as the case where the level monitoring unit 1102 becomes operatable after turning on or reset of the master apparatus is carried out, the case where passage of a certain period of time or of a predetermined time is detected, or the case where a predetermined level stored by the storing means for predetermined level is changed.

According to the fourth embodiment, it becomes possible to remove botheration in setting a predetermined level of the level monitoring unit 1102 with respect to each turning on etc. of the master apparatus, and to change the predetermined level as described hereinbelow.

As the fifth embodiment of the present invention, the bidirectional optical communication system, wherein the ‘predetermined level’ described in the second embodiment is changeable, will be described.

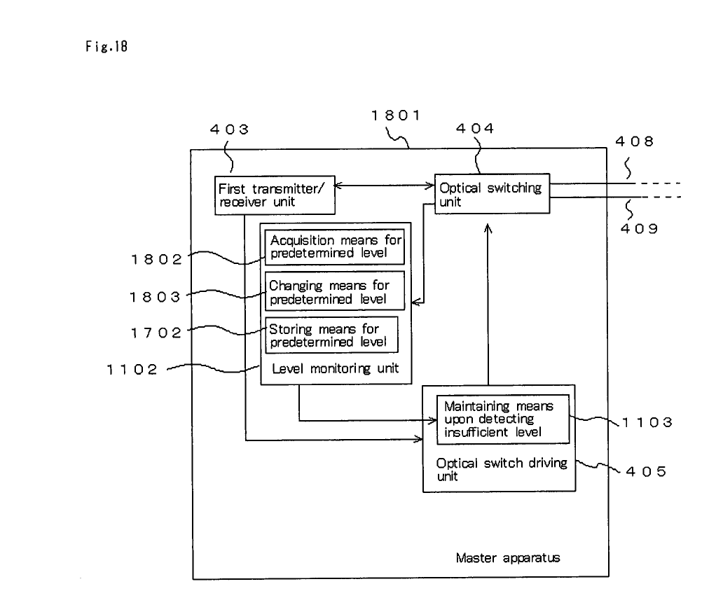

FIG. 18 is a functional block diagram of the master apparatus of the bidirectional optical communication system of the fifth embodiment of the present invention. The master apparatus 1801 comprises the first transmitter/receiver unit 403, and the optical switching unit 404, and the optical switch driving unit 405, and the optical switch driving unit 405 may comprise the maintaining means upon detecting insufficient level 1103, and the level monitoring unit 1102 comprises the storing means for predetermined level 1702, the acquisition means for predetermined level 1802, and the changing means for predetermined level 1803. The configuration of the slave apparatus is the same as that of the fourth embodiment. Therefore, the bidirectional optical communication system of the fifth embodiment is the bidirectional optical communication system according to the fourth embodiment, wherein the level monitoring unit of the master apparatus comprises the acquisition means for predetermined level and the changing means for predetermined level

The ‘acquisition means for predetermined level’ 1802 acquires the predetermined level to be stored by the storing means for predetermined level. This acquisition may be carried out, for example, by acquiring a value inputted to the input apparatus connected to the master apparatus 1801. For example, the input apparatus may be a personal computer, which comprises a keyboard, a mouse, and a display, and to which an operator of the master apparatus can input the value.

In addition, the acquisition means for predetermined level 1802 may appropriately generate the level. For example, in cases where the operation of an amplifier of the signal in the standby line changes according to passage of time, a different level according to the passage of time may be generated.

The ‘changing means for predetermined level’ 1803 changes the predetermined level stored by the storing means for predetermined level 1702 to the level acquired by the acquisition means for predetermined level 1802.

Accordingly, in the fifth embodiment, when a level is acquired by the acquisition means for predetermined level 1802, the changing means for predetermined level 1803 changes the predetermined level stored by the storing means for predetermined level 1702 to the level acquired by the acquisition means for predetermined level 1802. After that, the level monitoring unit 1102 reads a predetermined level stored by the storing means for predetermined level according to necessity, and compares the read level and the level of the optical signal transmitted from the slave apparatus via the standby line.

According to the fifth embodiment, it becomes possible to change the level of the optical signal, at which the maintaining means upon detecting insufficient level 1103 operates. For example, in cases where the number of transmission means of the second transmitter/receiver unit, or in cases where setting of an amplifier for the standby line is changed, it becomes possible to set an appropriate level.

As the sixth embodiment of the present invention, the bidirectional optical communication system, which detects number of transmission means of the second transmitter/receiver unit, and changes the ‘predetermined level’, will be described.

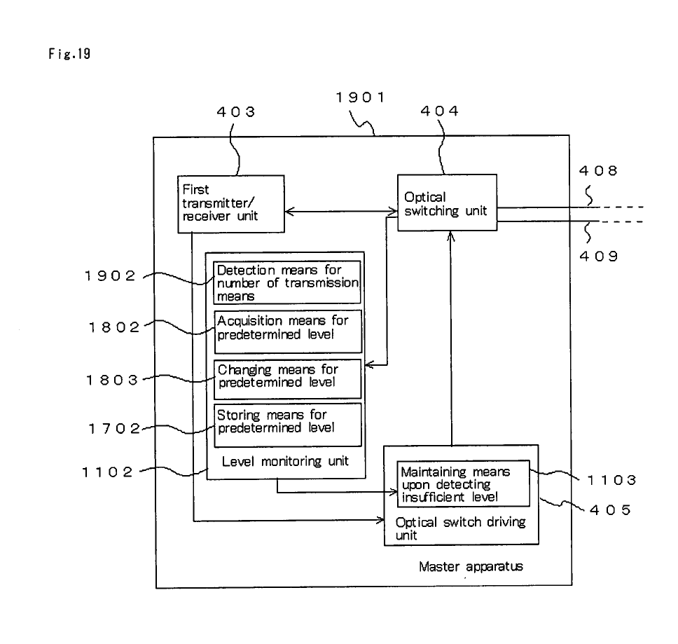

FIG. 19 is a functional block diagram of the master apparatus of the bidirectional optical communication system of the sixth embodiment of the present invention. The master apparatus 1901 comprises the first transmitter/receiver unit 403, and the optical switching unit 404, and the optical switch driving unit 405, and the optical switch driving unit 405 may comprise the maintaining means upon detecting insufficient level 1103, and the level monitoring unit 1102 comprises the storing means for predetermined level 1702, the acquisition means for predetermined level 1802, the changing means for predetermined level 1803, and the detection means for number of transmission means 1902. The configuration of the slave apparatus is the same as that of the fifth embodiment. Therefore, the bidirectional optical communication system of the sixth embodiment is the bidirectional optical communication system according to the fifth embodiment, wherein the level monitoring unit of the master apparatus comprises the detection means for number of transmission means 1902.

The ‘the detection means for number of transmission means’ 1902 detects number of transmission means, which transmits the optical signal, of the second transmitter/receiver unit 407. For example, at least one transmission means of the second transmitter/receiver unit 407 transmits information indicating a configuration of the second transmitter/receiver unit 407, which includes the number of the transmission means etc., and based on the transmitted information, the detection means for number of transmission means 1902 detects the number of the transmission means. Alternatively, in cases where transmission is carried out by means of different wavelengths with respect to each transmission means, by measuring intensity of the optical signal for the wavelength, and by detecting number of maximal points of the intensity, it becomes possible to detect the number of transmission means.

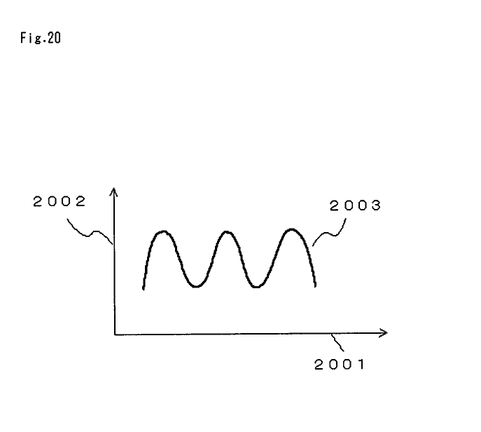

FIG. 20 is a graph in which the horizontal axis 2001 indicates wavelength, and the vertical axis 2002 indicates optical signal level. In this case, three maximal points exist, so that the number of transmission means is three.

In the sixth embodiment, the acquisition means for predetermined level 1802 acquires the level based on the number detected by the detection means for number of transmission means 1902. For example, the value acquired by multiplying a preliminary determined value for one transmission means by the number of transmission means is generated as a level.

According to the sixth embodiment, level according to the number of transmission means of the second transmitter/receiver unit is a predetermined level, so that it becomes possible to appropriately determine whether interruption occurs in the standby line.

The bidirectional optical communication system of the present invention is effective in carrying out smooth switching between an active line and a standby line in the case of interruption, and is beneficial in industrial use.

1. A bidirectional optical communication system, comprising:
a master apparatus, comprising
a first transmitter/receiver unit, which transmits/receives an optical signal,
an optical switching unit, which is able to select an active line or a standby line to be connected to said first transmitter/receiver unit, and
an optical switch driving unit, which drives said optical switching unit; and
a slave apparatus, comprising
an optical coupler unit, which couples said active line and standby line, and
a second transmitter/receiver, which is connected to said optical coupler unit, wherein
said optical switch driving unit of said master apparatus normally connects the active line to the first transmitter/receiver, and drives the optical switching unit to connect the standby line to the first transmitter/receiver if bad communication status of the active line is detected through the optical signal received by said first transmitter/receiver.

2. The bidirectional optical communication system according to claim 1, wherein
said master apparatus comprises
a level monitoring unit, which monitors the optical signal transmitted from said slave apparatus via said standby line, and
said optical switch driving unit comprises
a maintaining means upon detecting insufficient level, which maintains the connection to said optical switching unit if said level monitoring unit detects that level of said optical signal is lower than a predetermined level.

3. The bidirectional optical communication system according to claim 1 or 2, wherein
said master apparatus comprises
a monitoring unit for communication status of active line, which is able to monitor a communication status of the active line, and
said optical switch driving unit comprises
an acquisition means for approval signal, which acquires an approval signal for causing said optical switching unit to connect the active line and the first transmitter/receiver if said optical switching unit of said master apparatus connects the standby line to the first transmitter/receiver, and said monitoring unit for communication status of active line detects good communication status of the active line.

4. The bidirectional optical communication system according to claim 2, wherein
said level monitoring unit comprises
a storing means for predetermined level, which stores said predetermined level.

5. The bidirectional optical communication system according to claim 4, wherein
said level monitoring unit comprises
an acquisition means for predetermined level, which acquires the predetermined level to be stored by said storing means for predetermined level, and
a changing means for predetermined level, which changes the predetermined level stored by said storing means for predetermined level to the level acquired by said acquisition means for predetermined level.

6. The bidirectional optical communication system according to claim 5, wherein
said level monitoring unit comprises
a detection means for number of transmission means, which detects number of transmission means, which transmits the optical signal, of the second transmitter/receiver unit, and
said acquisition means for predetermined level, acquires the level based on the number detected by said detection means for number of transmission means.

7. A method for operating a bidirectional optical communication system, which comprises
a master apparatus, comprising
a first transmitter/receiver unit, which transmits/receives an optical signal, and
an optical switching unit, which is able to select an active line or a standby line for connection to said first transmitter/receiver unit, and
a slave apparatus, comprising
an optical coupler unit, which couples said active line and standby line, and
a second transmitter/receiver, which is connected to said optical coupler unit, comprising:
a connecting step in normal cases, which connects the active line and the first transmitter/receiver unit to said optical switching unit in normal cases; and
a connecting step in abnormal cases, which connects the standby line and the first transmitter/receiver unit to said optical switching unit if bad communication status of the active line is detected through the optical signal received by said first transmitter/receiver.

8. A master apparatus of a bidirectional optical communication system, comprising:
a first transmitter/receiver unit;
an optical switching unit, which is able to select an active line or a standby line to be connected to the first transmitter/receiver unit;
a detection unit, which detects bad communication status of the active line through an optical signal received from a slave apparatus connected to the active line by said first transmitter/receiver; and
an optical switch driving unit, which causes said optical switching unit to execute switching to the standby line if bad communication status is detected by said detection unit.

9. A slave apparatus of a bidirectional optical communication system, comprising:
an optical coupler unit; and
a second transmitter/receiver, which performs transmission/reception of a signal inputted/outputted via the active line and/or standby line with a master apparatus through the optical coupler unit, wherein
said master apparatus normally carries out transmission/reception via the active line, and carries out transmission/reception via the standby line if bad communication status of the active line is detected.

10. A method for operating a master apparatus a bidirectional optical communication system, wherein
said master apparatus comprises
a first transmitter/receiver unit,
an optical switching unit, which is able to select an active line or a standby line to be connected to the first transmitter/receiver unit, and
a detection unit, which detects bad communication status of the active line through an optical signal received from a slave apparatus connected to the active line by said first transmitter/receiver, and
said optical switching unit is caused to execute switching to the standby line if bad communication status is detected by said detection unit.
